(19) United States
(12) Patent Application Publication
(10) Pub. No.: US 2013/0332102 A1
(43) Pub. Date: Dec. 12, 2013

(54) VERIFICATION TESTING SYTEM

(71) Applicant: YEN-YU CHIANG, NEW TAIPEI CITY (TW)

(72) Inventor: YEN-YU CHIANG, NEW TAIPEI CITY (TW)

(73) Assignee: ASKEY COMPUTER CORP.

(21) Appl. No.: 13/557,440

(22) Filed: Jul. 25, 2012

(30) Foreign Application Priority Data
Jun. 7, 2012 (TW) 101120506

(51) Int. Cl. G06F 19/00

(52) U.S. Cl. 702/122

(57) ABSTRACT

A verification testing system includes an electronic device and a testing platform. The verification testing system verifies a hardware function of the electronic device by using the testing platform. The testing platform includes an electrical connection unit, a driving unit, a library unit, a transmission interface unit, and a verification unit. The electronic device sends testing data to the electrical connection unit of the testing platform via a connection interface. The driving unit drives the electrical connection unit to receive the testing data. The library unit converts the testing data into key event data and then sends the key event data to the transmission interface unit. The verification unit decodes the key event data, outputs a testing result, and evaluates the hardware function of the electronic device based on the testing result.

### CROSS-REFERENCE TO RELATED APPLICATION

This non-provisional application claims priority under 35 U.S.C. §119(a) on Patent Application No(s).101120506 filed in Taiwan, R.O.C. on Jun. 7, 2012, the entire contents of which are hereby incorporated by reference.

### FIELD OF TECHNOLOGY

The present invention relates to a testing system, in particular to the verification testing system for verifying hardware functions of an electronic device.

### BACKGROUND

In prior arts, electronic products such as Smartphones, tablet PCs, notebook computers, desktop computers and portable multimedia devices are generally bundled with an operating system such as Symbian, Windows Mobile, Win 8, iOS, Linux (including Android, Maemo and WebOS), Palm OS and BlackBerry OS and MAC OS.

Electronic devices that require additional peripherals are mainly divided into two types: (a) Electronic devices with a standard equipment including keyboard and mouse, wherein a built-in driver program of the electronic product is provided for driving the electronic product directly if such electronic devices are connected to the electronic product; and (b) Electronic devices with a non-standard equipment including a magnetic stripe reader device and a scanner device, wherein such electronic devices require installing an additional driver program before the electronic product can use the electronic device.

As to the electronic devices with non-standard equipments, manufacturers have to assure that the electronic devices can be operated under the aforementioned operating systems before they are shipped out from factories, and thus a verification test must be conducted to confirm that the operating system can drive the operation of the electronic device.

However, the manufacturers have no way to know which application program under which operating system is used in the electronic device by a user in advance, so that the manufacturers cannot confirm whether the electronic device can be used directly in the electronic product during the verification test.

Therefore, the present invention provides a verification testing system for verifying the hardware function of the electronic device.

### SUMMARY

It is a primary objective of the present invention to provide a verification testing system, wherein a simulation application program is used to operate the electronic device and achieve the effect of verifying the hardware function of the electronic device.

To achieve the aforementioned objective, the present invention provides a verification testing system, comprising: an electronic device, a testing platform, an electrical connection unit, a driving unit, a library unit, a transmission interface unit and a verification unit. Wherein, the electronic device has a connection interface for generating testing data, and sending out the testing data via the connection interface; the testing platform is bundled with an operating system and further comprises: the electrical connection unit coupled to the connection interface; the driving unit coupled to the electrical connection unit for driving the electrical connection unit to receive the testing data; the library unit coupled to the driving unit for pre-storing a transfer function, and converting the testing data into key event data by the transfer function and sending out the key event data; the transmission interface unit coupled to the library unit for receiving the key event data; and the verification unit coupled to the transmission interface unit for decoding the key event data to output a testing result.

Compared with the prior art, the present invention provides a verification testing system, wherein a simulation application program installed in the operating system of the testing platform is used for verifying the hardware function of the electronic device during a testing stage to determine whether the electronic device can be driven and used normally under the operating system.

In addition, the present invention can perform verification tests for a plurality of electronic devices of different types or functions (such as a magnetic stripe reader device and a scanner device) on the same testing platform simultaneously, and the testing platform can select an appropriate testing procedure for the verification based on the desired testing electronic device.

### BRIEF DESCRIPTION OF THE DRAWINGS

FIG. 1 is a schematic block diagram of a verification testing system in accordance with a first preferred embodiment of the present invention;

FIG. 2 is a schematic block diagram of a verification testing system in accordance with a second preferred embodiment of the present invention;

FIG. 3 is a schematic block diagram of a verification testing system in accordance with a third preferred embodiment of the present invention; and

FIG. 4 is a schematic block diagram of a verification testing system in accordance with a fourth preferred embodiment of the present invention.

### DETAILED DESCRIPTION

The objects, characteristics and effects of the present invention will become apparent with the detailed description of the preferred embodiments and the illustration of related drawings as follows.

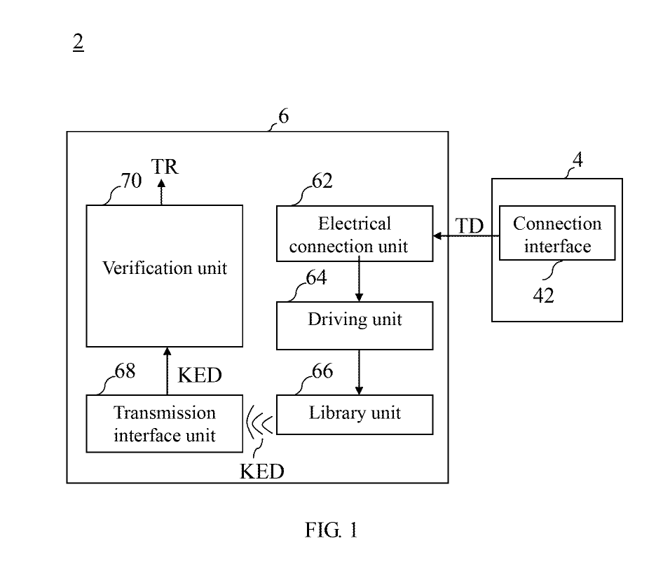

With reference to FIG. 1 for a schematic block diagram of a verification testing system in accordance with the first preferred embodiment of the present invention, the verification testing system 2 comprises an electronic device 4 and a testing platform 6. Wherein, the testing platform 6 tests a hardware function of the electronic device 4. The testing platform 6 pre-installs an operating system and simulates driving and operating the electronic device 4 under the operating system. Wherein, the testing platform 6 can be a Smartphone, a tablet PC, a notebook computer, a desktop computer or a portable multimedia device; and the operating system can be Symbian, Windows Mobile, Win 8, iOS, Linux (including Android, Maemo and WebOS), Palm OS and BlackBerry OS or MAC OS.

The testing platform 6 performs different verification tests based on the hardware function of the corresponding type of the electronic device 4. For example, the electronic device 4 is a magnetic stripe reader device or a scanner device.

In other words, if the electronic device 4 is the magnetic stripe reader device, the verification testing system 2 verifies whether the hardware function of the magnetic stripe reader device can read magnetic stripe data and display the magnetic stripe data at the testing platform 6 correctly; and if the electronic device 4 is the scanner device, the verification testing system 2 verifies whether the scanner device can perform the hardware function of capturing image data and displaying the image data at the testing platform 6 correctly.

The electronic device 4 and the testing platform 6 are described in details below:

### <Electronic Device>

The electronic device 4 has a connection interface 42. If the electronic device 4 generates testing data TD, the data can be outputted by the connection interface 42. Wherein, the electronic device 4 outputs the testing data TD from the connection interface 42 via a cable or wireless transmission. For example, the connection interface 42 is in compliance with a data transmission specification including Bluetooth, universal serial bus, infrared, wireless fidelity, fire wire and Apple 30-pins. Wherein, the testing data TD produce different modes based on the type of the electronic device 4. For example, if the electronic device 4 is the magnetic stripe reader device, the magnetic stripe reader device captures the magnetic stripe data which form a string comprised of a numeral, an alphabet or a combination character and used for forming the testing data TD; and if the electronic device 4 is the scanner device, the scanner device captures a pattern, a word, a barcode or a photo in the image data to form the testing data TD.

### <Testing Platform>

The testing platform 6 further comprises an electrical connection unit 62, a driving unit 64, a library unit 66, a transmission interface unit 68 and a verification unit 70.

Wherein, the electrical connection unit 62 is corresponsive to the connection interface 42 of the electronic device 4, so that the testing data TD can be outputted from the electronic device 4 to the testing platform 6. In other words, the electrical connection unit 62 and the connection interface 42 are in compliance with the same data transmission specification such as the Bluetooth, universal serial bus, infrared, wireless fidelity, fire wire and Apple 30-pins specifications, so that the electrical connection unit 62 can be used to receive the testing data

TD transmitted by the electronic device 4.

The driving unit 64 is coupled to the electrical connection unit 62, and the driving unit 64 drives the electrical connection unit 62 to receive the testing data TD from the electrical connection unit 62. Wherein, the driving unit 64 can be software or hardware, so that the testing platform 6 can control the electrical connection unit 62 by the driving unit 64 to receive the testing data TD of the electronic device 4.

The library unit 66 is coupled to the driving unit 64. Wherein, the library unit 66 pre-stores a transfer function, and the library unit 66 converts the testing data TD into key event data KED by the transfer function and outputs the key event data KED. Wherein, the transfer function includes a function for converting program codes of different programming languages into one another such as the conversion between C programming language and JAVA programming language. For example, the driving unit 64 codes programs in the C programming language, but the operating system is operated by the JAVA programming language, and thus the operating system can use the driving unit 64 through the conversion of the library unit 66. In addition, the key event data KED and the testing data TD substantially have the same contents, and their only difference resides on that the key event data KED and the testing data TD are applicable for the data structures of different programming languages.

The transmission interface unit 68 is coupled to the library unit 66, and the transmission interface unit 66 is used for receiving the key event data KED. Wherein, the transmission interface unit 68 outputs the key event data KED to the verification unit 70 by a broadcasting method and/or an assigning method.

In the broadcasting method, the transmission interface unit 68 receives the key event data KED and provides the key event data KED to the verification unit 70 at a rear end to determine whether to perform a test; if yes, then the key event data KED are transmitted to the verification unit 70, or else the transmission interface unit 68 continuously waits for other key event data KED. Wherein, the broadcasting method is applied in one or more verification units 70 of the electronic devices 4 of various different types. In other words, the transmission interface unit 68 matches the verification unit 70 based on the type of the electronic device 4, so that the key event data KED can perform the verification test by a correct verification unit 70.

In the assigning method, the key event data KED are assigned to the transmission interface unit 68 specifically by the library unit 66. Wherein, one transmission interface unit 68 is used in this example, and the library unit 66 will specify or not specify the transmission interface unit 68 to receive the data.

In addition, the transmission interface unit 68 transmits the key event data KED in the testing platform 6 via a cable or wireless transmission.

The verification unit 70 is coupled to the transmission interface unit 68, and the verification unit 70 is used for decoding the key event data KED to output a testing result TR.

For example, if the testing result TR outputted by the verification unit 70 shows that the electronic device 4 is verified to be situated at a normal status, and the electronic device 4 is the magnetic stripe reader device, then the verification unit 70 will receive a string having the same numerals, alphabets and combination characters of the testing data; and if the electronic device 4 is the scanner device, then the verification unit 70 will receive a pattern, a word, a barcodes or a photo which is the same as that of the testing data.

On the other hand, if the testing result TR shows that the electronic device 4 fails to pass the verification test, then the electronic device 4 will be unable to provide hardware functions normally. In other words, the electronic device 4 will not be able to read the magnetic stripe data or capture the image data correctly.

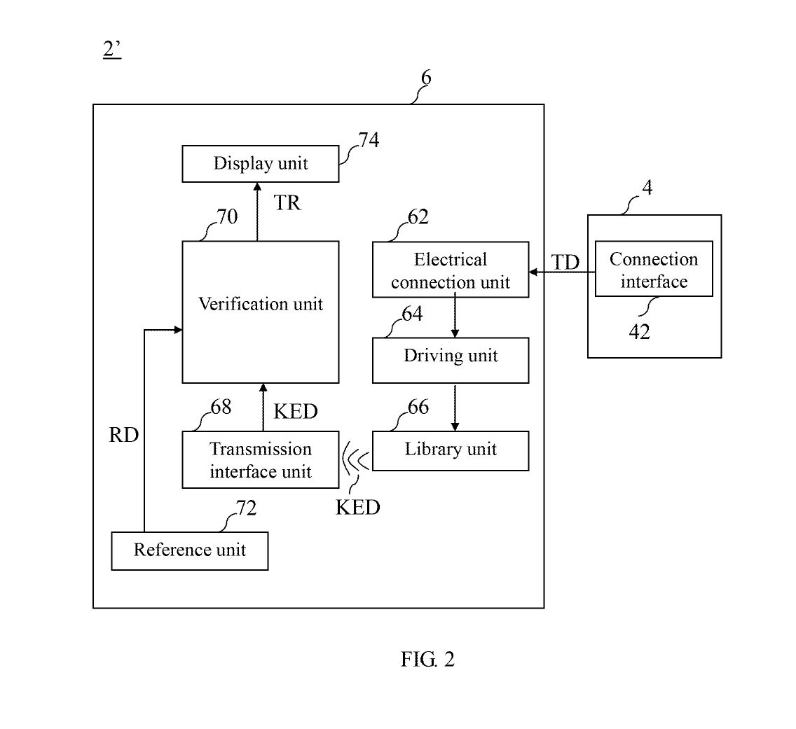

With reference to FIG. 2 for a schematic block diagram of a verification testing system in accordance with the second preferred embodiment of the present invention, the verification testing system 2′ further comprises a reference unit 72 and a display unit 74 in addition to the electronic device 4 and the testing platform 6.

Wherein, the reference unit 72 is coupled to the verification unit 70, and the reference unit 72 saves reference data RD related to the testing data TD in advance, and the reference data RD are used by the verification unit 70 to obtain the information whether the electronic device 4 can pass the hardware function verification test by comparing the reference data RD with the testing result TR.

In addition, the display unit 74 is coupled to the verification unit 70 for displaying the testing result TR, and the display unit 74 displays the testing result TR indicating whether or not the electronic device 4 has passed the hardware function verification test.

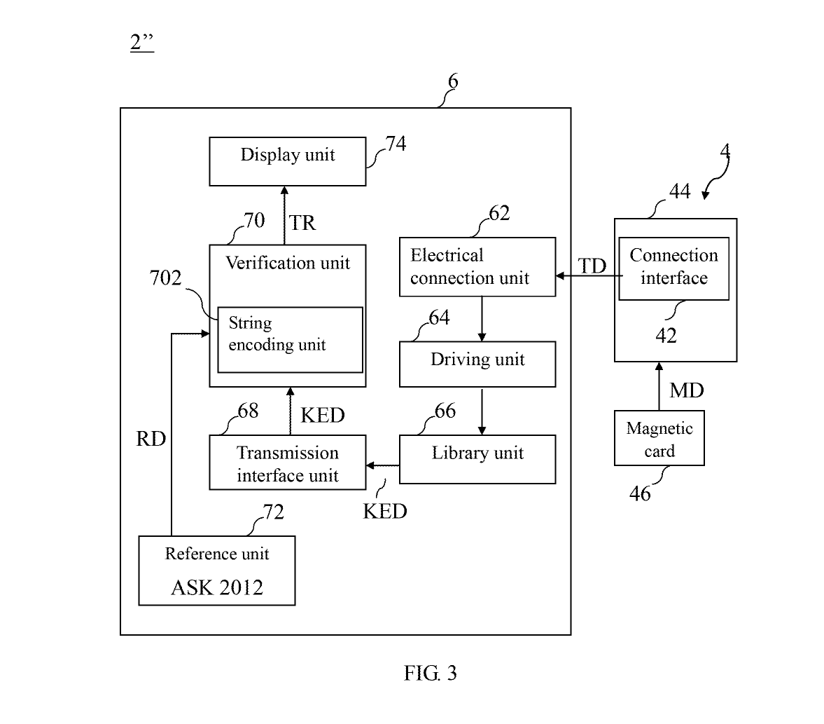

With reference to FIG. 3 for a schematic block diagram of a verification testing system in accordance with the third preferred embodiment of the present invention, the verification testing system 2″ comprises the electronic device 4. the testing platform 6, the reference unit 72 and the display unit 74. Wherein, the electronic device 4 of this preferred embodiment is a magnetic stripe reader device 44.

In this preferred embodiment, a magnetic card 46 containing magnetic stripe data MD such as “ASK2012” is provided. The magnetic stripe reader device 44 reads the magnetic stripe data MD, and the string is divided by the connection interface 42 and single characters (such as “A”-“S”-“K”-“2”-“0”-“1”-“2”) are outputted sequentially to the electrical connection unit 62.

The electrical connection unit 62 receives the characters “A”-“S”-“K”-“2”-“0”-“1”-“2” sequentially. In addition, the reference unit 72 also saves a string of “ASK2012” which is the same as the magnetic stripe data MD.

Now, the character “A” is used for example. After the electrical connection unit has received the character “A”, the library unit 66 broadcasts the character “A” by the key event data KED and outputs the character “A” to the transmission interface unit 68. Further, the transmission interface unit 68 receives the key event data KED and determines whether the verification unit 70 coupled to the transmission interface unit 68 can perform a verification application of the magnetic stripe reader device 44. If the verification unit 70 is used for verifying the magnetic stripe reader device 44, then the transmission interface unit 68 will send the character “A” to the verification unit 70 again. In other words, the electrical connection unit 62 obtains the testing data TD including the magnetic stripe data MD from the magnetic stripe reader device 44, and the testing data TD including the magnetic stripe data MD are converted by the library unit 66 and then outputted, and the key event data KED are decoded by a string encoding unit 702 of the verification unit 70, and the testing result TR of the magnetic stripe data MD is outputted.

In addition, the verification unit 70 obtains the character “A” of the most significant bit in the string “ASK2012” from the reference unit 72, and the character “A” is compared with the character “A” transmitted from the transmission interface unit 68, and so forth. If two strings are the same after the strings are determined, the verification unit 70 will output a testing result TR indicating that the hardware function of the magnetic stripe reader device 44 (which is the function of reading the magnetic stripe data MD) passes the verification test successfully, and the display unit 74 displays the aforementioned testing result TR.

It is noteworthy that the verification unit 70 further comprises the string encoding unit 702 capable of converting the key event data KED including the character or the string into the corresponding character or string, particularly the corresponding combination character such as the magnetic stripe data MD including a combination character “@” which is comprised of two characters “shift”+“2”, so that when the string encoding unit 702 receives “shift”, the string encoding unit 702 will wait for another coming-up character before encoding the combination character. If “2” is received after “shift” is received, then “shift”+“2” will be encoded to generate “@”.

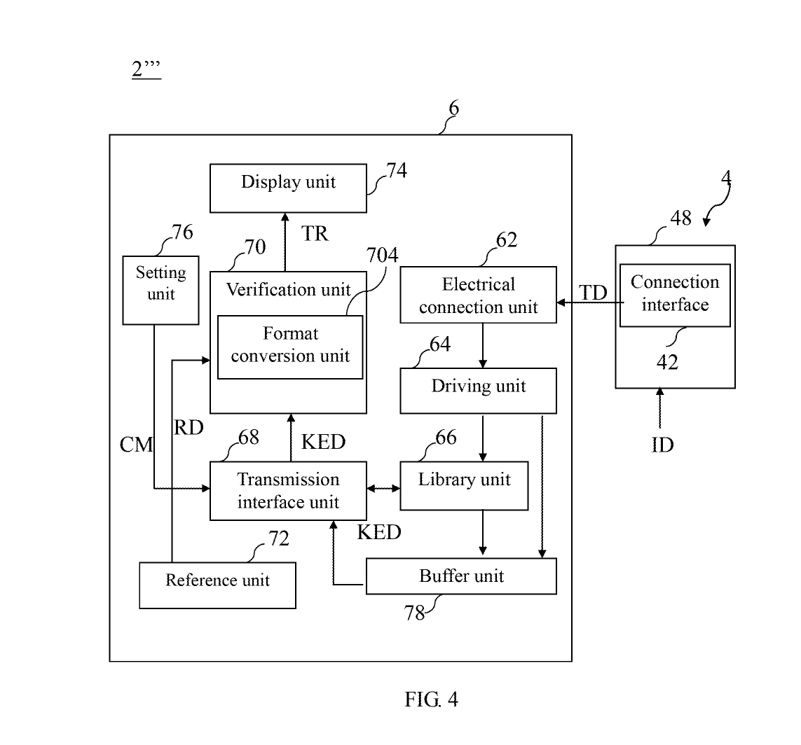

With reference to FIG. 4 for a schematic block diagram of a verification testing system in accordance with the fourth preferred embodiment of the present invention, the verification testing system 2′″ comprises the electronic device 4, the testing platform 6, the display unit 74, a setting unit 76 and a buffer unit 78. Wherein, the electronic device 4 used in this example is a scanner device 48.

The scanner device 48 is provided for capturing image data ID. Wherein, the image data ID can be in a RAW image file format, a bitmap image file format, a tagged image file format and/or a joint photographic experts group (JPEG) image file format. Wherein, the image data ID of this example are lossless images in the RAW image file format.

The scanner device 48 outputs the image data ID to the testing platform 6, and the testing platform 6 is used for outputting the key event data KED of the RAW image file format through the library unit 66, and the key event data KED of the RAW image file format are outputted to the verification unit 70 through the transmission interface unit 68, and the verification unit 70 verifies the RAW image file format to obtain the testing result TR and outputs the testing result to the display unit 74. Wherein, the display unit 74 may not be able to display the key event data KED of the RAW image file format directly, and must use a format conversion unit 704 coupled to the transmission interface unit 68 to format the key event data KED in order to convert the image type of the key event data KED.

For example, the display unit 74 can display data in the bitmap image file format only, and if the verification unit 70 receives the key event data KED of the RAW image file format, then the conversion of the image types made by the format conversion unit 704 will convert the key event data KED of the RAW image file format into the key event data KED of the bitmap image file format, so that the key event data KED can be displayed by the display unit 74. Wherein, a header for displaying the bitmap image file format is added in front of the key event data KED of the RAW image file format and used for converting the key event data KED of the RAW image file format into the key event data KED of the bitmap image file format.

In addition, the setting unit 76 is coupled to the transmission interface unit 68 and the setting unit 76 provides a set command CM and sends the set command CM to the scanner device 48 through the transmission interface unit 68, the library unit 66, the driving unit 64 and the electrical connection unit 62. In other words, when the hardware function of the scanner device 48 is verified, the setting unit 76 executes at least one selected from an initialization command, a start command and an end command of the scanner device 48 to issue commands such as displaying a plurality of image data, and starting or ending the capture of image data to the scanner device 48.

The buffer unit 78 is installed between the library unit 66 and the transmission interface unit 68. Wherein, the buffer unit 78 is provided for saving the key event data KED outputted by the library unit 66, and the library unit 66 sends the key event data KED to the transmission interface unit 68 through the buffer unit 78 to assure the display unit 74 can display of a plurality of image data from the electronic device 4.

The present invention provides a verification testing system, wherein during the testing stage, a simulation application program installed in the operating system of the testing platform is used for verifying the hardware function of the electronic device to determine whether or not the electronic device can be driven and used normally in the operating system. In addition, the present invention performs tests for a plurality of electronic devices with different functions (such as a magnetic stripe reader device and a scanner device) by the same testing platform simultaneously, and the testing platform can select an appropriate testing procedure for the test based on the electronic device.

While the invention has been described by means of specific embodiments, numerous modifications and variations could be made thereto by those skilled in the art without departing from the scope and spirit of the invention set forth in the claims.

What is claimed is:

1. A verification testing system, comprising:
an electronic device, having a connection interface, for generating testing data, and sending out the testing data via the connection interface;
a testing platform, bundled with an operating system, and further comprising:
an electrical connection unit, coupled to the connection interface;
a driving unit, coupled to the electrical connection unit, for driving the electrical connection unit to receive the testing data;
a library unit, coupled to the driving unit, for pre-storing a transfer function, and converting the testing data into key event data by the transfer function and sending out the key event data;
a transmission interface unit, coupled to the library unit, for receiving the key event data; and
a verification unit, coupled to the transmission interface unit, for decoding the key event data to output a testing result.

2. The verification testing system of claim 1, wherein the connection interface and the electrical connection unit comply with a data transmission specification selected from the collection of Bluetooth, universal serial bus, infrared, wireless fidelity, fire wire and Apple 30-pins.

3. The verification testing system of claim 1, wherein the library unit outputs the key event data to the verification unit by a broadcasting method and/or an assigning method.

4. The verification testing system of claim 1, wherein the transmission interface unit selectively matches the verification unit according to the type of the electronic device.

5. The verification testing system of claim 1, wherein the electronic device is one selected from the collection of a magnetic stripe reader device and a scanner device.

6. The verification testing system of claim 5, wherein the electrical connection unit obtains the testing data including the magnetic stripe data from the magnetic stripe reader device, and converts the testing data by the library unit to output the key event data including the magnetic stripe data, and the key event data are decoded by the verification unit, and the testing result of the magnetic stripe data is outputted.

7. The verification testing system of claim 6, wherein the magnetic stripe data form a string comprised of at least one selected from the collection of a numeral, an alphabet and a combination character.

8. The verification testing system of claim 5, wherein the scanner device is provided for capturing image data, when the library unit outputs the key event data including the image data to the verification unit through the transmission interface unit, and the verification unit verifies the image data to obtain the testing result.

9. The verification testing system of claim 8, wherein the verification unit further comprises a format conversion unit coupled to the transmission interface unit for formatting the key event data, used for converting the type of the key event data.

10. The verification testing system of claim 9, wherein the image data have an image file format selected from the collection of a RAW image file format, a bitmap image file format, a tagged image file format and a joint photographic experts group (JPEG) image file format.

11. The verification testing system of claim 9, further comprising a buffer unit installed between the library unit and the transmission interface unit for storing the key event data outputted by the library unit, and provided for the library to transmit the key event data to the transmission interface unit through the buffer unit.

12. The verification testing system of claim 1, wherein the verification unit further comprises a setting unit coupled to the transmission interface unit for providing a set command, and transmitting the set command to the electronic device via the transmission interface unit, the library unit, the driving unit and the electrical connection unit.

13. The verification testing system of claim 12, wherein the setting unit outputs at least one command selected from the collection of an initialization command, a start command and an end command for controlling the electronic device.

14. The verification testing system of claim 1, further comprising a reference unit coupled to the verification unit for pre-storing reference data related to the testing data, and comparing the reference data with the testing result.

15. The verification testing system of claim 1, wherein the library unit converts the C programming language and the JAVA programming language into one another through the transfer function.

16. The verification testing system of claim 1, further comprising a display unit coupled to the verification unit for displaying the testing result.
